(19) United States
(12) Patent Application Publication
(10) Pub. No.: US 2016/0178029 A1
(43) Pub. Date: Jun. 23, 2016

(54) REFRIGERANT COMPRESSOR

(71) Applicants: Valeo Compressor S.R.O., Humpolec (CZ); Valeo Japan Co., Ltd., Saitama (JP)

(72) Inventors: Ichiro Hirano, Saitama (JP); Katsumi Sakamoto, Saitama (JP); Masanori Amemori, Saitama (JP); David Ceverny, Humpolec (CZ)

(73) Assignees: Valeo Japan Co., Ltd., Saitama (JP); Valeo Compressor S.R.O., Humpolec (CZ)

(21) Appl. No.: 14/971,377

(22) Filed: Dec. 16, 2015

(30) Foreign Application Priority Data
Dec. 18, 2014 (EP) 14198963.2

(51) Int. Cl. F16F 15/14; F04B 17/05

(52) U.S. Cl. CPC F16F 15/14; F04B 17/05

(57) ABSTRACT

The invention provides a refrigerant compressor comprising a shaft (16) having an axial direction (A), a hub (14) mounted on the shaft (16) and an inertia disk (20), the inertia disk (20) being directly connected to the hub (14) in a torque-transmitting manner.

The invention relates to a refrigerant compressor for an air conditioning unit, in particular for a motor vehicle, where a drive pulley is connected to a compressor shaft to operate the air conditioning unit.

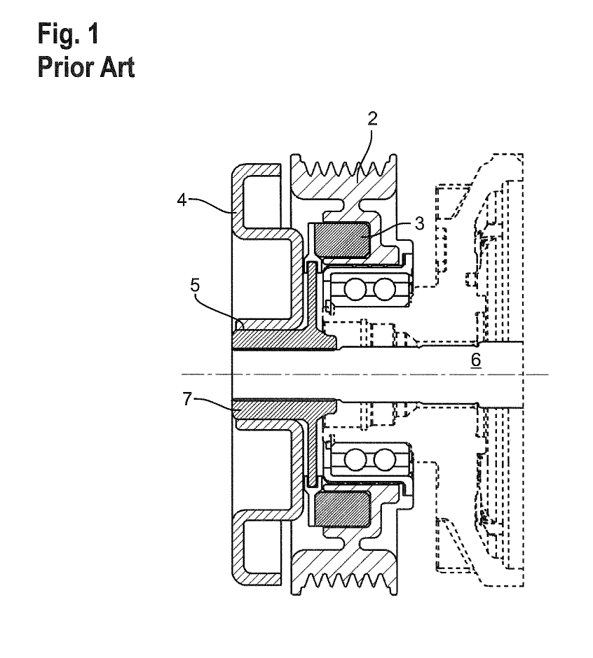

A refrigerant compressor of this type is known from DE 102 54 937 B4. As shown in the schematic view in FIG. 1, a drive pulley 2 is connected via a torque limiter element 3 to a hub member 7. Rotation of the drive pulley 2 is transmitted to the hub member 7, which drives the compressor shaft 6. In such arrangements, vibration can arise in the compressor drive assembly due to the various components having their own resonance frequencies, including the drive belt, pulley, bearings, shaft, etc. To avoid such vibrational phenomena, a flywheel or inertia disk 4 is fixed to the hub member 7 as shown in FIG. 1. The inertia disk 4 is connected to an outer periphery surface of the hub member 7 in a press-fit connection 5. The disk acts as an inertial mass, which increases the inertial moment of the compressor drive assembly and can consequently shift the natural resonance frequency of the system.

One drawback associated with the conventional arrangement of the flywheel or inertia disk relates to the mechanical connection between the disk 4 and the outer surface of the hub member 7. In the construction of the prior art in FIG. 1, the disk is connected to the hub through a press-fit arrangement, while in other configurations (not shown), the disk can be connected to the hub by a threaded connection. These arrangements have the disadvantage that when the rotational speed of the vehicle engine is suddenly changed, in particular suddenly increased or decreased, the rotational speed of the pulley changes accordingly. This results in abrupt variations in the torque transmitted by the pulley 2 to the shaft 6 through the hub member 7. In view of the larger mass of the inertia disk 4 a torque or twisting moment acts on the connection interface 5 between the hub and the disk.

When the connection is formed by press-fit, a repeated and sudden torque load and a reversal of torque applied to the interface can cause material fatigue and eventually a failure of the connection.

When the connection 5 is a threaded connection, the repeated reversal of the applied torque direction at the connection can cause a loosening of the screw connection. Either result is undesirable and can eventually lead to an unwanted disengagement of the disk from hub member and possibly associated damage of the compressor system.

The object of the present invention is to propose a configuration of the inertia disk which will avoid the undesirable resonance frequencies in the compressor drive assembly, while at the same time will improve the reliability and durability of the mechanical connection of the inertia mass element to the hub member.

According to the invention, the object is achieved by a refrigerant compressor comprising a shaft having an axial direction, a hub mounted on the shaft and an inertia disk, the inertia disk being directly connected to the hub in a torque-transmitting manner. The invention is based on the recognition that connecting the inertia disk directly to the hub avoids many of the prior art problems which are due to the fact that the torque between the hub and the inertia disk is transmitted indirectly via the compressor shaft. By avoiding the detour via the compressor shaft, less elasticity is involved in the torque flow path, resulting in reduced a load on the connection between the hub and the inertia disk.

Preferably, the inertia disk is connected to the hub by means of a press-fit connection. This connection can be achieved at low costs with high reliability.

According to a preferred embodiment, a circular collar protrudes from the inertia disk in an axial direction and engages with the hub. A circular collar allows providing an axial displacement path for establishing the press-fit connection.

Preferably, the circular collar engages the interior of a cylindrical sleeve of the hub in a press-fit connection. By choosing suitable dimensions for the sleeve, the rigidity of the press-fit connection can be established in the desired manner.

In order to achieve a stronger connection of the inertia disk, it can in addition be connected to the shaft with a press-fit connection.

According to another preferred embodiment, the inertia disk is connected to the hub by means of a threaded connection. Here again, using a direct connection between the hub and the inertia disk improves the torque flow from the hub to the inertia disk, thereby allowing using connection which in the prior art designs have shown some critical behavior.

According to another preferred embodiment, the inertia disk is connected to the hub by means of a positive engagement connection. This type of connection reliably avoids any risk of rotation of the inertia disk relative to the hub.

Preferably, one of the elements hub and inertia disk is provided with a plurality of axially extending lugs which engage with openings provided in the other element. Such design is compact and does not require much space in an axial direction.

According to another preferred embodiment, the inertia disk is connected to the hub by means of a welded connection. This type of connection, which can be used as the only connection between the inertia disk and the hub or as a connection in addition to those previously discussed, provides a very secure connection which ensures that the inertia disk be connected to the hub even in case of vibrations.

Preferably, the hub engages with the shaft in a spline connection. Such connection has a high strength and does not introduce much torsional elasticity into the torque flow path.

A nut can be provided to cooperate with a threading on the shaft and urge the inertia disk in axial direction against the hub. The nut acts as a securing means and thereby improves the safety level.

Preferably, a surface of the nut is urged against a radial surface of the inertia disk to form a frictional connection. This frictional connection increases the admissible torque which can be transmitted to the inertia disk and thereby increases the strength of the connection between the compressor shaft and the inertia disk.

According to a preferred embodiment, the nut is a cap nut. The cap nut seals or closes the axial end of the compressor shaft which can be provided with an internal thread.

Preferable, a shoulder is provided at the shaft. The shaft is being used for axially positioning the hub and/or the inertia disk, thereby positively determining the axial position of the disk in a reliable manner.

In one embodiment, the inertia disk engages at the shoulder with an axial end. The shoulder can contribute to torque transmission between the inertia disk and the compressor shaft, thereby increasing the strength of the connection between disk and shaft.

In an alternative embodiment, the hub is arranged between the shoulder and the inertia disk. The hub thus is sandwiched between the inertia disk and the shoulder such that the shoulder provides for an axial position of both the hub and inertia disk. Here again, the shoulder can contribute to torque transmission between the inertia disk and (via the hub) the compressor shaft, thereby increasing the strength of the connection between disk and shaft.

According to an embodiment of the invention, the shaft is provided with an internal thread, the internal thread being covered by the cap nut. Thus, there is no risk of the internal thread being exposed to dirt.

Preferably, the inertia disk is made from steel as this allows achieving a high inertia with a compact design.

In a preferred embodiment, the inertia mass is a disk (or flywheel), which is constructed to provide additional inertia in the range of 200 to 800 kg·mm².

In one embodiment, the disk is provided with a circular collar which protrudes in axial direction along the compressor shaft. The outer surface of the circular collar engages with an interior surface of the hub in a press-fit connection.

In another embodiment, the disk can be connected to the hub by means of a threaded connection or a positive engagement connection.

In a further embodiment, either the hub or the inertia disk is provided with a plurality of axially projecting lugs. The lugs are provided and arranged to engage with openings in the other of the hub or disk. In this type of mechanical connection, the disk is directly coupled to the hub in a positive mechanical engagement.

In a further embodiment, a nut is provided which cooperates with a threading on the shaft, and is disposed so as to urge the disk in axial direction against the hub. In particular, when the nut is turned down, an end face of the nut is urged against a radial surface of the inertia disk. With this an additional frictional connection is provided for fixation of the disk, specifically through friction at a thrust surface of the inertia disk. Preferably, the nut is a cap nut.

In another preferred embodiment, a shoulder or step portion is provided on the shaft, which acts as a stop. In the mounted condition, an axial end of the disk abuts against the shoulder. In this arrangement, the inertia disk is sandwiched between the nut and the step portion. The overall fixation is then further improved. In addition to the press-fit connection between the cylindrical surfaces of the hub and the disk, the two end faces of the inertia disk engage in frictional connections with an end face of the nut at one end and the shoulder at the other end. The frictional connections at these two end thrust surfaces further improve the reliability and strength of the direct connection between the inertia disk and the hub.

Further advantages of the present invention will now be described in conjunction with embodiments, which are shown in the following drawings,

FIG. 1 shows a schematic drawing of the drive pulley and flywheel assembly of a conventional compressor;

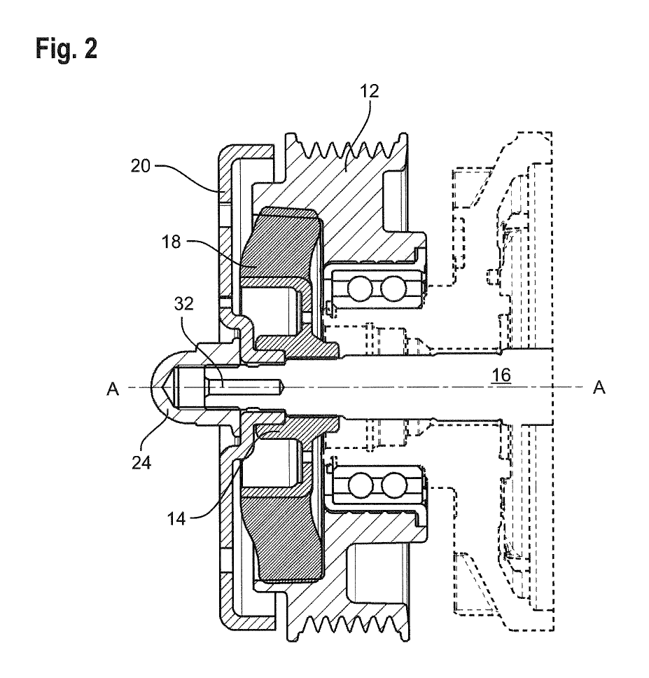

FIG. 2 shows a cross section through a compressor shaft and pulley assembly according to a first embodiment of the present invention;

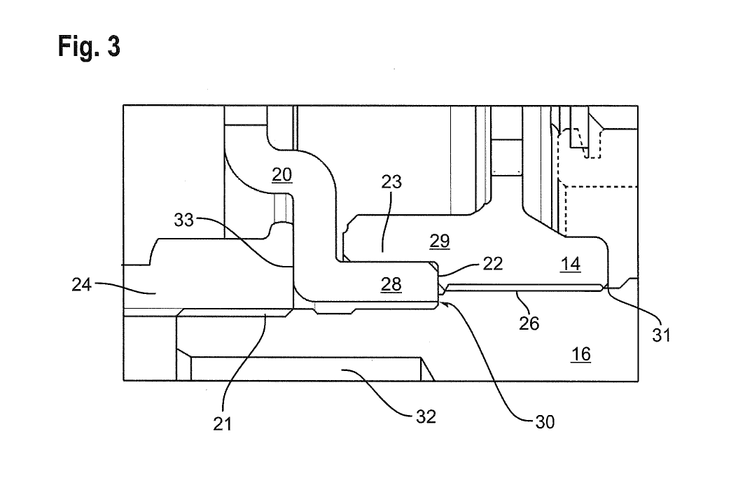

FIG. 3 shows an expanded detailed illustration of the interconnecting surfaces of the embodiment in FIG. 2;

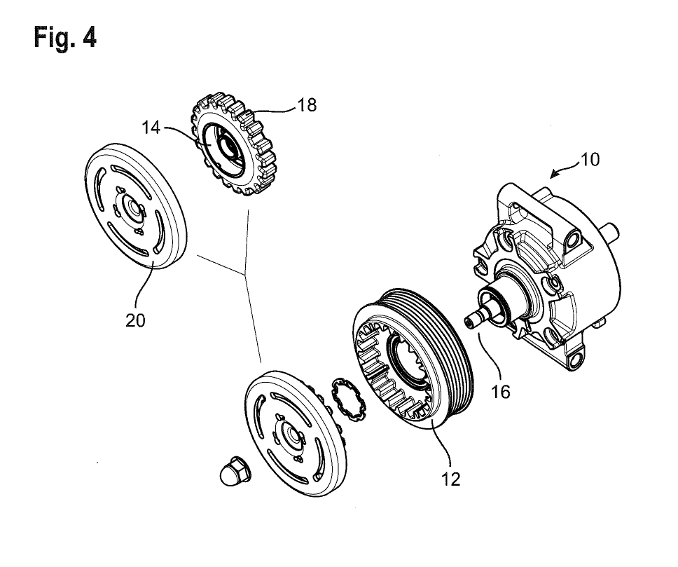

FIG. 4 shows a perspective of a compressor together with drive pulley and inertia mass element in an exploded view;

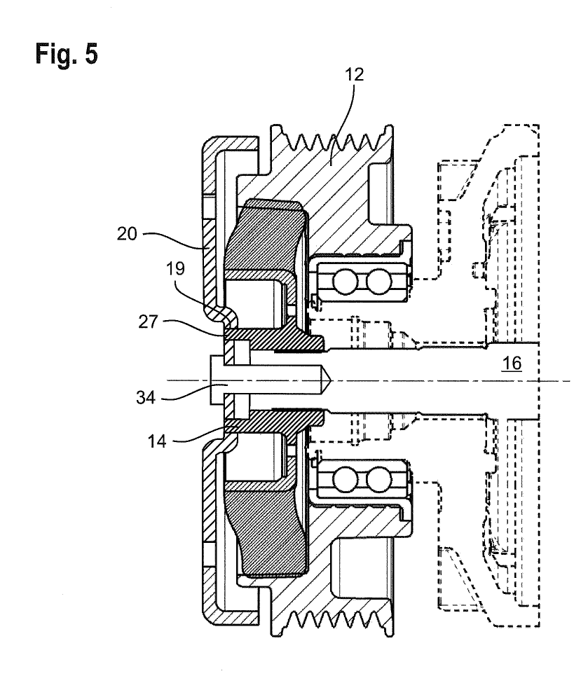

FIG. 5 shows a cross-sectional view of a further embodiment of the present invention;

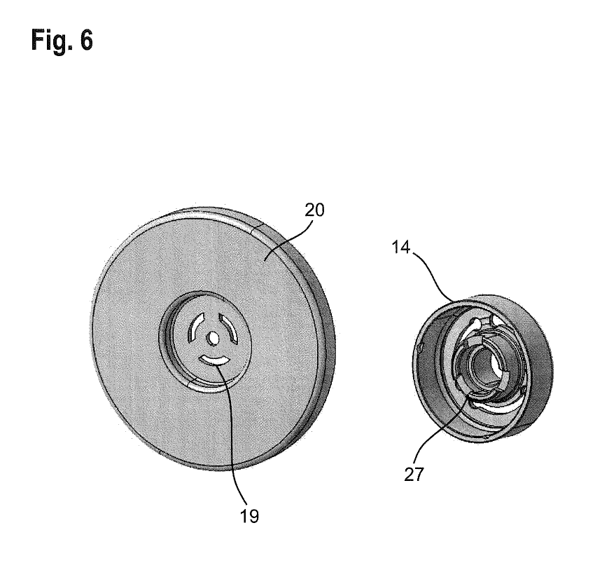

FIG. 6 shows perspective views of the inertia disk element and the hub of the embodiment of FIG. 5;

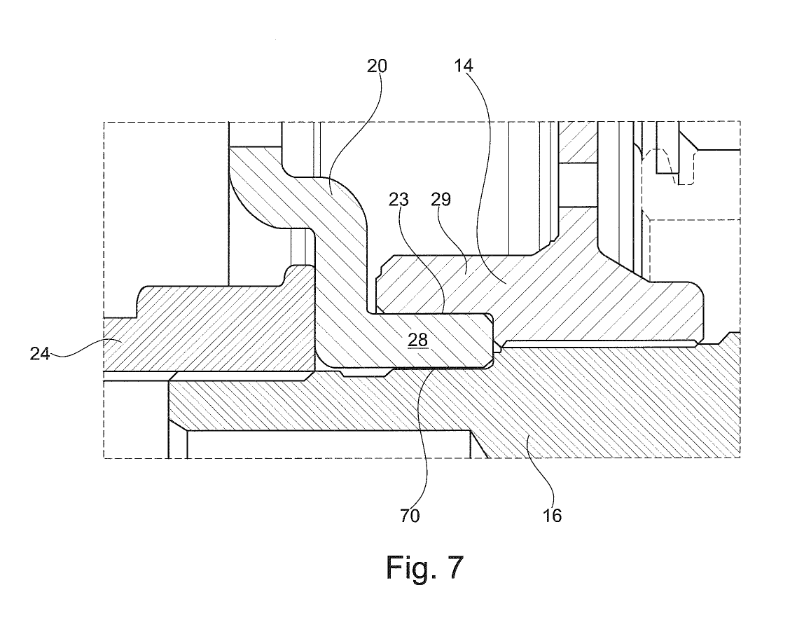

FIG. 7 shows a cross-sectional view of a still further embodiment of the invention;

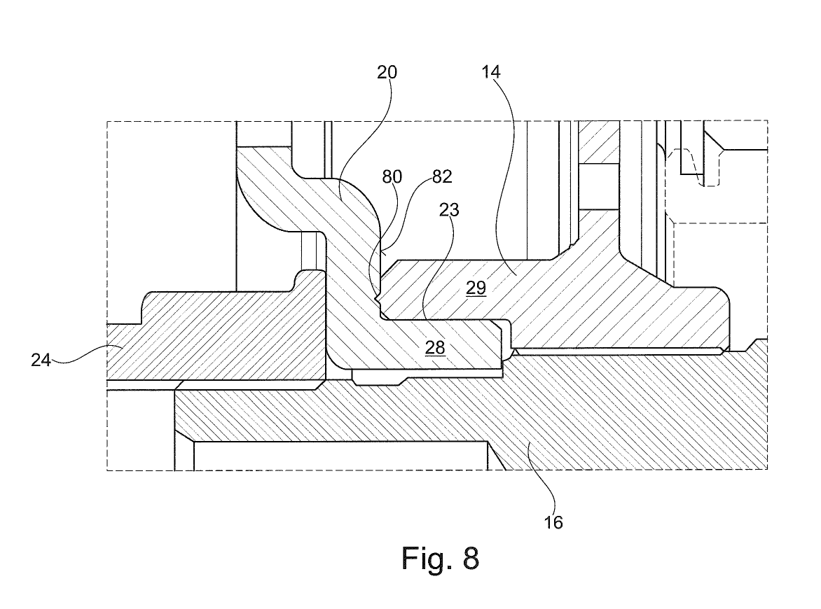

FIG. 8 shows a cross-sectional view of a still further embodiment of the invention; and

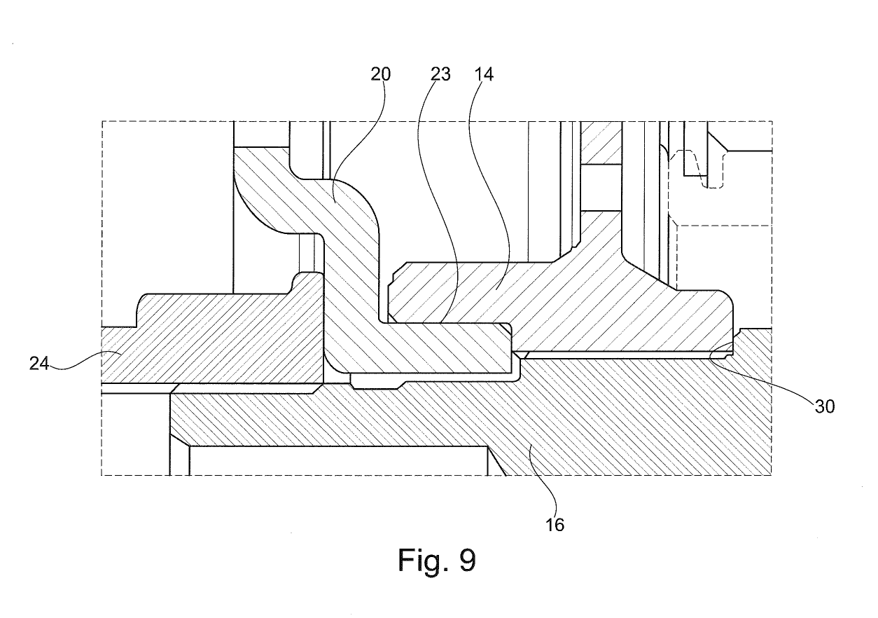

FIG. 9 shows a cross-sectional view of a still further embodiment of the invention.

FIG. 1 shows a schematic view of a refrigerant compressor of the prior art, which can be used in an air-conditioning system of a motor vehicle. As mentioned above, the connection 5 between the inertia disk 4 and the hub 7 is conventionally a press-fit or a threaded connection, neither of which is satisfactory and sustainable for prolonged use, in particular in view of the repeated changes in the direction and magnitude of torque applied by the drive pulley.

A first embodiment of the present invention is illustrated in FIG. 2, where an inertia disk 20 is directly connected to a hub 14 via multiple connection interfaces. A compressor shaft 16 extends along a central axis A and through the hub 14. The shaft 16 extends outwardly beyond the hub and has a free forward end. A nut 24 is engages the forward end of the shaft 16 so as to secure the inertia disk 20.

FIG. 3 shows a more detailed section of the embodiment of FIG. 2, in particular in relation to the fixation of a disk 20. A circular collar 28 protrudes from the disk 20 in axial direction and engages the hub 14. In particular, an outer surface of the circular collar 28 engages an interior surface of a cylindrical sleeve 29 of the hub in a press-fit connection. The press fit can be achieved by providing a slight taper on the interior cylindrical sleeve 29 of the shaft 16 and pressing the collar 28 in an axial direction into the cylindrical sleeve 29 until the collar abuts at an axial shoulder at the end of the sleeve.

Another example of a connection 23 between the disk 20 and the hub 14 would be a threaded connection between the collar 28 and the sleeve 29. In another preferable embodiment, the disk 20 could be connected to the hub 14 in a positive mechanic connection, for example with splines or keys provided on the cylindrical surfaces of the collar 28 and the sleeve 29.

Again referring to FIG. 3, the hub 14 itself is preferably attached to the shaft 16 in a spline connection 26. To assemble the drive members, the press-fit connection is first made between the disk 20 and the hub 14 and then the connected elements are fitted over the shaft. The splines of the interior of the hub 14 will then slide axially into the counter-splines on the outer surface of the shaft 16 to form the connection 26.

Although relating to a different embodiment, this procedure can be understood with reference to FIG. 4, which shows an exploded view of the compressor arrangement. The main compressor body with its shaft 16 allows the successive components of the drive assembly to be mounted on the shaft 16 and fixed to one another. The hub 14 and the disk 20 can be initially connected to one another and the combined unit can be slipped over the shaft 16.

The nut 24 provided at the forward end of the shaft 16 cooperates with a threading 21 on the shaft 16. When tightened, the nut urges the disk 20 in axial direction toward the hub 14. This produces a frictional connection 33 between a bottom end face of the nut 24 and a radial surface of the disk 20. This frictional connection 33 provides a further fixation force for the disk, apart from or in addition to the press-fit connection between the collar 28 and the sleeve 29.

The nut 24 is preferably a cap nut with a bottom face of sufficient radial extension as shown in FIG. 3. This mechanically seals the end portion of the compressor shaft.

The shaft 16 is provided with a shoulder 30 as shown in FIG. 3 which engages an axial end 22 of the disk 20 in the mounted condition. During assembly, the collar 28 and the cylindrical sleeve 29 are firstly connected in press-fit as mentioned. The combined assembly is then mounted onto the shaft and a forward end 22 of the circular collar 28 engages the step 30. Subsequently, the nut 24 is tightened down which urges the collar 28 against the shoulder 30. This provides a further frictional connection of the disk 20 at the thrust surface 22 of the collar 28.

In summary, both of the end faces of the inertia disk 20 seen in axial direction engage in frictional connections with an end face of the nut 24 at one end and at the shoulder 30 at the other end. The frictional contact at these two end thrust surfaces further improves the reliability and strength of the direct connection between the disk 20 and the hub 14.

As seen in FIG. 2, the shaft 16 further includes an internal thread 32 which can be used for different purposes. Cap nut 24 closes the internal thread so as to prevent that dirt or other contaminations can adversely affect the internal thread.

A further embodiment of the present invention is shown in FIGS. 5 and 6. The disk 20 is secured to the shaft 16 by the bolt 34, which acts largely for centering the inertia disk 20 with respect to the shaft 16. The hub 14, as best shown in FIG. 6, comprises a cylindrical protruding portion extending in the forward direction and having axially extending lugs 27. The lugs 27 engage in openings 19 of the disk 20.

The engagement of the lugs with the slot openings 19 ensures a positive mechanical connection for transmitting torque between the hub and the disk 20.

In FIG. 7, an additional embodiment is schematically shown. For the elements known from the previous embodiments, the same reference numerals are being used, and reference is made to the above comments.

The embodiment of FIG. 7 is based on the embodiment of FIGS. 2 and 3. However, in addition to the press-fit connection 23 between the circular collar 28 of the inertia disk 20 and the cylindrical sleeve 29 of the hub 14, a second press-fit connection 70 is established between an inner surface of the circular collar 28 and an external surface of compressor shaft 16.

In other words, circular collar 28 is sandwiched, in an axial direction, between the compressor shaft and the hub.

Thanks to the additional press-fit 70, any torque to be transmitted to the inertia disk 20 can be supported by both the hub 14 and the shaft 16. Further, the additional support thus provided for the inertia disk 20 helps maintaining it securely connected to the hub and the shaft even if there are some vibrations, e.g. due to the gravity center of the inertia disk not being on the axis of rotation or due to the inertia disk not being perfectly oriented perpendicularly to the compressor shaft.

In FIG. 8, an additional embodiment is schematically shown. For the elements known from the previous embodiments, the same reference numerals are being used, and reference is made to the above comments.

The embodiment of FIG. 8 is also largely based on the embodiment of FIGS. 2 and 3. In addition to the press-fit connection 23 between the circular collar 28 of the inertia disk 20 and the cylindrical sleeve 29 of the hub 14, a welded connection 80 is established between an axial end face of cylindrical sleeve 29 of hub 14 on the one hand, and a radially extending surface 82 of the inertia disk 20 on the other hand.

The welded connection 80 is formed by projection welding (resistance welding) where short projections on one element (here the hub 14) are pressed against the other element (here the inertia disk 20) while a current is made to flow between the elements. At the points of contact, a high temperature is being generated due to the electrical resistance, resulting in a local melting of the material of the elements.

The welded connection 80 provides a very reliable and secure connection between inertia disk 20 and hub 14 even in case of vibrations resulting from an imperfect orientation or balance of the inertia disk. Furthermore, the welded connection 80 is prevented from being subjected to excessive forces because of the press-fit connection 23 arranged close to the welded connection 80 and absorbing the majority of forces.

In FIG. 9, an additional embodiment is schematically shown. For the elements known from the previous embodiments, the same reference numerals are being used, and reference is made to the above comments.

Similar to the embodiment of FIGS. 2 and 3, the embodiment of FIG. 9 is provided with a shoulder 30 on the compressor shaft 16. The shoulder 30 however is arranged at a larger distance from the axial end of the compressor shaft 16 and it does not serve for axially positioning the inertia disk 20 directly. Rather, it is the hub 14 which abuts at shoulder 30. However, as the inertia disk 20 is inserted into the cylindrical sleeve 29 of the hub (and biased in an axial direction by means of nut 24 so as to be sandwiched, in an axial direction, between nut 24 and hub 14), the inertia disk 20 is positioned indirectly in an axial position.

In the embodiment of FIG. 9, a part of the torque to be transmitted from the hub 14 to the compressor shaft 16 can be transmitted via the frictional contact between hub 14 and shoulder 30 of the shaft 16.

1. A refrigerant compressor comprising:
a shaft having an axial direction
a hub mounted on the shaft; and
an inertia disk, the inertia disk being directly connected to the hub in a torque-transmitting manner.

2. The compressor of claim 1, wherein the inertia disk is connected to the hub by a press-fit connection.

3. The compressor of claim 2, wherein a circular collar protrudes from the inertia disk in an axial direction and engages with the hub.

4. The compressor of claim 3, wherein the circular collar engages the interior of a cylindrical sleeve of the hub in a press-fit connection.

5. The compressor of claim 2, wherein the inertia disk engages the shaft with a press-fit connection.

6. The compressor of claim 1, wherein the inertia disk is connected to the hub by a threaded connection.

7. The compressor of claim 1, wherein the inertia disk is connected to the hub by a positive engagement connection.

8. The compressor of claim 7, wherein one of the elements hub and inertia disk is provided with a plurality of axially extending lugs which engage with openings provided in the other element.

9. The compressor of claim 1, wherein the inertia disk is connected to the hub by a welded connection.

10. The compressor of claim 1, wherein the hub engages with the shaft in a spline connection.

11. The compressor according to claim 1, wherein a nut is provided to cooperate with a threading on the shaft and urges the inertia disk in axial direction against the hub.

12. The compressor of claim 8, wherein a surface of the nut is urged against a radial surface of the inertia disk to form a frictional connection.

13. The compressor of claim, wherein the nut is a cap nut.

14. The compressor according to claim 1, wherein a shoulder is provided at the shaft.

15. The compressor of claim 14, wherein the inertia disk engages at the shoulder with an axial end.

16. The compressor of claim 14, wherein the hub is arranged between the shoulder and the inertia disk.

17. The compressor according to claim 14, wherein the shaft is provided with an internal thread, the internal thread being covered by the cap nut.

18. The compressor according to claim 1, wherein the inertia disk is made from steel.

19. The compressor according to claim 1, wherein additional inertia provided by the inertia disk is between 200 and 800 kg*mm².
